(19) United States
(12) Patent Application Publication
(10) Pub. No.: US 2022/0382842 A1
(43) Pub. Date: Dec. 1, 2022

(54) AUTHENTICATION ELECTRONIC DEVICE BASED ON BIOMETRIC TEMPLATE AND OPERATING METHOD THEREOF

(71) Applicant: Electronics and Telecommunications Research Institute, Daejeon (KR)

(72) Inventors: Tae Wook KANG, Daejeon (KR); Seong-Eun KIM, Seoul (KR); Kwang IL OH, Daejeon (KR); Jae-Jin LEE, Daejeon (KR)

(73) Assignee: Electronics and Telecommunications Research Institute, Daejeon (KR)

(21) Appl. No.: 17/825,453

(22) Filed: May 26, 2022

(30) Foreign Application Priority Data
May 31, 2021 (KR) 10-2021-0070394
Sep. 24, 2021 (KR) 10-2021-0126185

(51) Int. Cl. G06F 21/32; G06N 3/08

(52) U.S. Cl. CPC G06F 21/32; G06N 3/08

(57) ABSTRACT

Disclosed are a biometric template-based authentication electronic device and an operating method thereof. The electronic device includes a memory, a transmitter that transmits a chirp signal, of which a frequency is changed, to a user, a receiver that obtains a biometric channel response signal, which responds to the transmitted chirp signal, from the user, and at least one processor that executes a biometric template authentication module based on machine learning. When executing the biometric template authentication module, the processor obtains a feature signal from the obtained biometric channel response signal, generates a biometric template from the obtained feature signal, performs the machine learning such that identification information of the user is inferred from the generated biometric template, and authenticates the user based on the result of the machine learning.

### CROSS-REFERENCE TO RELATED APPLICATIONS

This application claims priority under 35 U.S.C. § 119 to Korean Patent Applications No. 10-2021-0070394 filed on May 31, 2021, and No. 10-2021-0126185 filed on Sep. 24, 2021, in the Korean Intellectual Property Office, the disclosures of which are incorporated by reference herein in their entireties.

### BACKGROUND

Embodiments of the present disclosure described herein relate to an electronic device, and more particularly, relate to a biometric template-based authentication electronic device using a difference in unique biometric channel characteristics for each person, and an operating method thereof.

After personal information is converted into digital information with the development of Internet of Things (IoT) technology, thereby accessing the personal information without restrictions of place and time. Accordingly, a security technology for high-level authentication is required to prevent the personal information from being leaked. In a case of an authentication method using a medium such as a conventional ID card, a conventional credit card, or the like, personal information may be stolen by others when the corresponding medium is lost. In the case of biometric authentication using a person's unique biometric characteristics, forgery cases have already been reported several times in fingerprint recognition, iris recognition, and face recognition. When biometric information is leaked in a biometric authentication method, there is no alternative method. When two or more pieces of biometric information are combined or biometric authentication is used together with a conventional security measures such as a public certificate, the risk of forgery or leakage may be reduced. However, these alternative methods may reduce the convenience that is the greatest advantage of biometric authentication.

### SUMMARY

Embodiments of the present disclosure provide an authentication electronic device that generates a biometric template by using a unique biometric channel model extracted from a biometric channel response signal, and is based on the biometric template, an operating method thereof.

According to an embodiment, an electronic device includes a memory, a transmitter that transmits a chirp signal, of which a frequency is changed, to a user, a receiver that obtains a biometric channel response signal, which responds to the transmitted chirp signal, from the user, and at least one processor that executes a biometric template authentication module based on machine learning. When executing the biometric template authentication module, the processor obtains a feature signal from the obtained biometric channel response signal, generates a biometric template from the obtained feature signal, performs the machine learning such that identification information of the user is inferred from the generated biometric template, and authenticates the user based on the result of the machine learning.

In an electronic device according to an embodiment of the present disclosure, the obtaining of the feature signal may include generating a plurality of envelop signals corresponding to peak values of the obtained biometric channel response signal.

In an electronic device according to an embodiment of the present disclosure, the generating of the biometric template may include generating the biometric template by combining the generated plurality of envelop signals.

In an electronic device according to an embodiment of the present disclosure, the plurality of envelop signals may include an upper-envelop signal and a lower-envelop signal.

In an electronic device according to an embodiment of the present disclosure, an up-chirp signal having an increasing frequency and a down-chirp signal having a decreasing frequency, which are included in the chirp signal, may be continuous.

In an electronic device according to an embodiment of the present disclosure, the receiver may filter the biometric channel response signal to remove noise, may amplify the filtered biometric channel response signal, and may convert the amplified biometric channel response signal into a digital signal.

In an electronic device according to an embodiment of the present disclosure, the machine learning may be based on at least one of k-nearest neighbors (KNN), support vector machine (SVM), or convolutional neural network (CNN).

According to an embodiment, an operating method of an electronic device registering a biometric template by using a processor includes transmitting, by the processor, a chirp signal, of which a frequency is changed, to a user through a transmitter, obtaining, by the processor, a biometric channel response signal, which responds to the transmitted chirp signal, from the user through a receiver, obtaining, by the processor, a feature signal from the obtained biometric channel response signal, generating, by the processor, a first biometric template from the obtained feature signal, and performing, by the processor, machine learning such that identification information of the user is inferred from the generated first biometric template.

In an operating method according to an embodiment of the present disclosure, the operating method may further include receiving a registration request of the user. The performing, by the processor, of the machine learning may be performed in response to the registration request of the user.

In an operating method according to an embodiment of the present disclosure, the operating method may further include authenticating the user based on the result of the machine learning.

In an operating method according to an embodiment of the present disclosure, the authenticating of the user may include obtaining a second biometric template from the user and inferring the identification information of the user from the second biometric template.

In an operating method according to an embodiment of the present disclosure, the machine learning is based on at least one of KNN, SVM, or CNN.

In an operating method according to an embodiment of the present disclosure, the obtaining of the feature signal may include generating a plurality of envelop signals corresponding to peak values of the obtained biometric channel response signal.

In an operating method according to an embodiment of the present disclosure, the generating of the first biometric template may include generating the first biometric template by combining the generated plurality of envelop signals.

In an operating method according to an embodiment of the present disclosure, the plurality of envelop signals may include an upper-envelop signal and a lower-envelop signal.

### BRIEF DESCRIPTION OF THE FIGURES

The above and other objects and features of the present disclosure will become apparent by describing in detail embodiments thereof with reference to the accompanying drawings.

FIG. 1 illustrates a block diagram of an electronic device, according to embodiments of the present disclosure.

FIG. 2 illustrates a biometric template authentication module, according to an embodiment of the present disclosure.

FIG. 3 is a diagram illustrating an example of an electronic device, according to an embodiment of the present disclosure.

FIG. 4 illustrates a signal applied to a user to measure a biometric channel response signal, according to an embodiment of the present disclosure.

FIG. 5 illustrates feature signals of users obtained from biometric channel response signals, according to an embodiment of the present disclosure.

FIG. 6 is a flowchart of an electronic device by using a biometric template, according to an embodiment of the present disclosure.

FIG. 7 illustrates a generated biometric template, according to an embodiment of the present disclosure.

FIGS. 8A to 8D illustrate authentication results according to KNN and SVM algorithms for 15 users, according to an embodiment of the present disclosure.

### DETAILED DESCRIPTION

Hereinafter, embodiments of the present disclosure will be described with reference to the accompanying drawings in detail and clearly to such an extent that an ordinary one in the art easily implements the present disclosure.

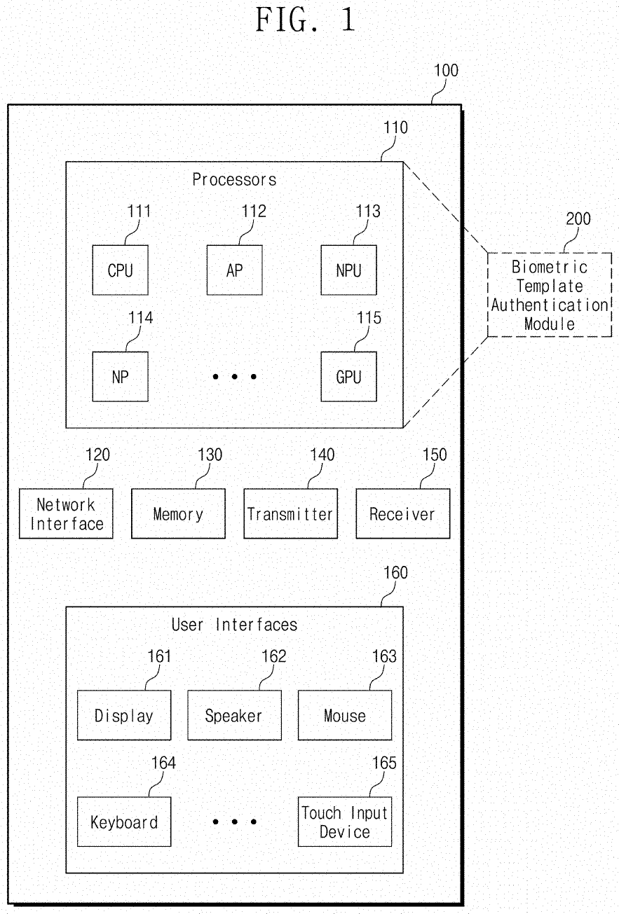

FIG. 1 is a block diagram illustrating an electronic device 100, according to an embodiment of the present disclosure. Referring to FIG. 1, the electronic device 100 may include a biometric template authentication module 200, processors 110, a network interface 120, a memory 130, a transmitter 140, a receiver 150, and user interfaces 160.

The processors 110 may function as a central processing unit of the electronic device 100. At least one of the processors 110 may drive the biometric template authentication module 200. The processors 110 may include, for example, at least one general-purpose processor such as a central processing unit (CPU) 111 or an application processor (AP) 112. Also, the processors 110 may further include at least one special-purpose processor such as a neural processing unit (NPU) 113, a neuromorphic processor 114, or a graphics processing unit (GPU) 115. The processors 110 may include two or more homogeneous processors. As another example, at least one (or at least another) processor among the processors 110 may be manufactured to implement various machine learning or deep learning modules.

At least one of the processors 110 may be used to learn the biometric template authentication module 200. At least one of the processors 110 may learn the biometric template authentication module 200 based on various pieces of data or information.

At least one (or at least another) of the processors 110 may execute the biometric template authentication module 200. The biometric template authentication module 200 may generate a biometric template based on machine learning or deep learning. For example, at least one (or at least another one) of the processors 110 may obtain a feature signal from a biometric channel response signal obtained through the receiver 150 by executing the biometric template authentication module 200. At this time, the feature signal may be generated from a plurality of envelope signals corresponding to peak values of the obtained biometric channel response signal.

At least one (or at least another) of the processors 110 may generate a first biometric template for registration from the obtained feature signal by executing the biometric template authentication module 200. At least one (or at least another) of the processors 110 may obtain a new feature signal from the same user by executing the biometric template authentication module 200. At least one (or at least another one) of the processors 110 may generate a second biometric template for authentication from a new feature signal by executing the biometric template authentication module 200. At this time, at least one (or at least one other) of the processors 110 may authenticate a user through the first biometric template and the second biometric template by executing the biometric template authentication module 200. At least one processor may store the first biometric template and the second biometric template in the memory 130.

For example, the biometric template authentication module 200 may be implemented in a form of instructions (or codes) that are executed by at least one of the processors 110. In this case, the at least one processor may load instructions (or codes) of the biometric template authentication module 200 onto the memory 130.

As another example, at least one (or at least another) of the processors 110 may be manufactured to implement the biometric template authentication module 200. For example, the at least one processor may be a dedicated processor implemented in hardware based on the biometric template authentication module 200 generated by the learning of the biometric template authentication module 200.

As another example, at least one (or at least another) processor among the processors 110 may be manufactured to implement various machine learning or deep learning modules. For example, at least one (or at least another) of the processors 110 may perform machine learning such that a user's identification information is inferred from the generated first biometric template. At this time, the result (e.g., identification information of a user who has requested registration) of machine learning may be stored in the memory 130. At least one (or at least another) of the processors 110 may infer the identification information of the user from the second biometric template for authentication. At least one (or at least another) of the processors 110 may determine whether the inferred identification information of the user corresponds to the user's identification information stored in the memory 130. At least one of the processors 110 may complete authentication in response to a fact that the inferred identification information of the user corresponds to the user's identification information stored in the memory 130.

Moreover, the at least one processor may implement the biometric template authentication module 200 by receiving information (e.g., instructions or codes) corresponding to the biometric template authentication module 200.

The network interface 120 may provide remote communication with an external device. The network interface 120 may communicate wirelessly or wired with the external device. The network interface 120 may communicate with the external device based on at least one of various communication schemes such as Ethernet, wireless-fidelity (Wi-Fi), long term evolution (LTE), and 5th generation (5G) mobile communication. For example, the network interface 120 may communicate with an external device of the electronic device 100.

The network interface 120 may receive calculation data to be processed by the electronic device 100 from the external device. The network interface 120 may output result data generated by the electronic device 100 to the external device. For example, the network interface 120 may store the result data in the memory 130.

The memory 130 may store data and process codes, which are processed or scheduled to be processed by the processors 110. For example, in some embodiments, the memory 130 may store data to be entered into the electronic device 100 or pieces of data generated or learned in a process of performing a deep neural network by the processors 110. For example, the memory 130 may store biometric templates generated from the electronic device 100.

Under the control of the processors 110, the memory 130 may store a user's authentication information such that the user's identification information is inferred by performing machine learning on the biometric templates generated from the electronic device 100. For example, under the control of the processors 110, the memory 130 may store and register the first biometric template thus generated. The user may be authenticated through the registered first biometric template and the second biometric template for authentication. When machine learning is performed on the second biometric template under the control of the processors 110, the result of the machine learning may be stored in the memory 130.

The memory 130 may be used as a main memory device of the electronic device 100. The memory 130 may include a dynamic random access memory (DRAM), a static RAM (SRAM), a phase-change RAM (PRAM), a magnetic RAM (MRAM), a ferroelectric RAM (FeRAM), a resistive RAM (RRAM), or the like.

The transmitter 140 may output a signal for obtaining a biometric template to the user. The transmitter 140 may transmit a signal suitable for measuring a human body's unique response (or a biometric channel characteristic) to the user's body in contact with a portion of the body. For example, a contact surface of the transmitter 140 may include an electrode made of a conductor such as copper.

The transmitter 140 may transmit a signal in a predetermined frequency band (e.g., 1 MHz to 10 MHz), which is a signal for obtaining a biometric template, to the user. Besides, the transmitter 140 may transmit a frequency-changing signal as a signal for obtaining a biometric template. For example, the transmitter 140 may transmit at least one of an up-chirp signal of which the frequency is increased during a given time and a down-chirp signal of which the frequency is decreased during a given time.

The receiver 150 may receive a signal for obtaining a biometric template from the user. The receiver 150 may receive a biometric channel response signal that has passed through the user. For example, the transmitter 140 may transmit a frequency-changing chirp signal to the user, and the receiver 150 may receive a biometric channel response signal from a user in response to the frequency-changing chirp signal

Unlike the illustration of FIG. 1, each of the transmitter 140 and the receiver 150 may be implemented as separate hardware for obtaining the biometric channel response signal. For example, each of the transmitter 140 and the receiver 150 may be at least one electronic device such as a smart phone, a portable personal computer, a wearable device, a tablet computer, a mobile device, and a television set (TV). The transmitter 140 and the receiver 150 may be implemented as various types of electronic devices in addition to the above-described electronic devices. At this time, the transmitter 140 and the receiver 150 may transmit data to the electronic device 100 through the network interface 120.

The user interfaces 160 may receive information from the user and may provide information to the user. The user interfaces 160 may include at least one user output interface such as a display 161 or a speaker 162, and at least one user input interface such as a mouse 163, a keyboard 164, or a touch input device 165.

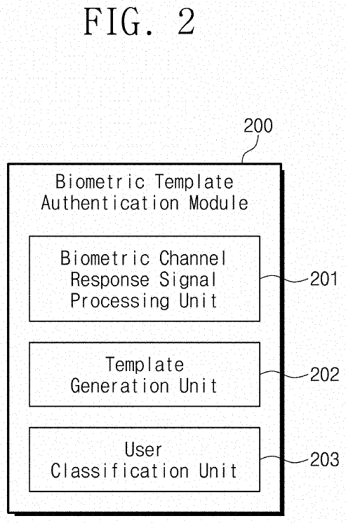

FIG. 2 illustrates a biometric template authentication module, according to an embodiment of the present disclosure. Referring to FIG. 2, the biometric template authentication module 200 may include a biometric channel response signal processing unit, a template generation unit, and a user classification unit. The biometric channel response signal processing unit, the template generation unit, and the user classification unit may be a part of the computation space. In this case, each of the biometric channel response signal processing unit, the template generation unit, and the user classification unit may be implemented in firmware or software. For example, the firmware may be stored in the memory 130 and may be loaded and executed by the processors 110.

Under the control of the processors 110, the biometric channel response signal processing unit may generate a feature signal by extracting a biometric channel feature from the biometric channel response signal. For example, the receiver 150 may transmit a biometric channel response signal obtained from a user to the biometric channel response signal processing unit.

The biometric channel response signal processing unit may generate a user-specific feature signal from the received biometric channel response signal.

Under the control of the processors 110, the template generation unit may generate a biometric template from a signal that has passed through the biometric channel response signal processing unit. For example, the biometric channel response signal processing unit may generate a feature signal and may transmit the feature signal to the template generation unit. The template generation unit may generate a biometric template based on the received feature signal. Furthermore, the template generation unit may receive a plurality of feature signals from the biometric channel response signal processing unit and may generate one biometric template by combining the plurality of feature signals. At this time, under the control of the processors 110, the network interface 120 transmits the generated biometric template to the memory 130. The memory 130 may store the received biometric template.

The user classification unit may perform machine learning such that the identification information of the user is inferred from the biometric template. The user classification unit may perform user authentication by using a biometric template. For example, the user classification unit may perform machine learning such that the identification information of the user is inferred from the biometric template generated by the template generation unit. When the user requests authentication, the user classification unit may obtain the user's biometric template, may infer the user from the obtained biometric template, and may perform user authentication by determining whether the inferred user is a registered user. At this time, the user classification unit may select one of biometric templates stored in the memory 130.

Under the control of the processors 110, the biometric template authentication module 200 or another module driven by the processors 110 may perform machine learning by using the biometric channel response signal and the generated biometric template. Also, the biometric template authentication module 200 or the other module driven by the processors 110 may perform machine learning (or re-learning or additional study) based on registration and authentication of a user.

As another example, the biometric channel response signal processing unit, the template generation unit, and the user classification unit may be implemented as separate hardware for generating a biometric template. For example, the biometric channel response signal processing unit, template generation unit, and user classification unit may be implemented as a neuromorphic chip for generating a biometric template by performing learning through an artificial neural network, and performing authentication based on the biometric template, or may be implemented as a dedicated logic circuit such as a field programmable gate array (FPGA) or an application specific integrated circuit (ASIC).

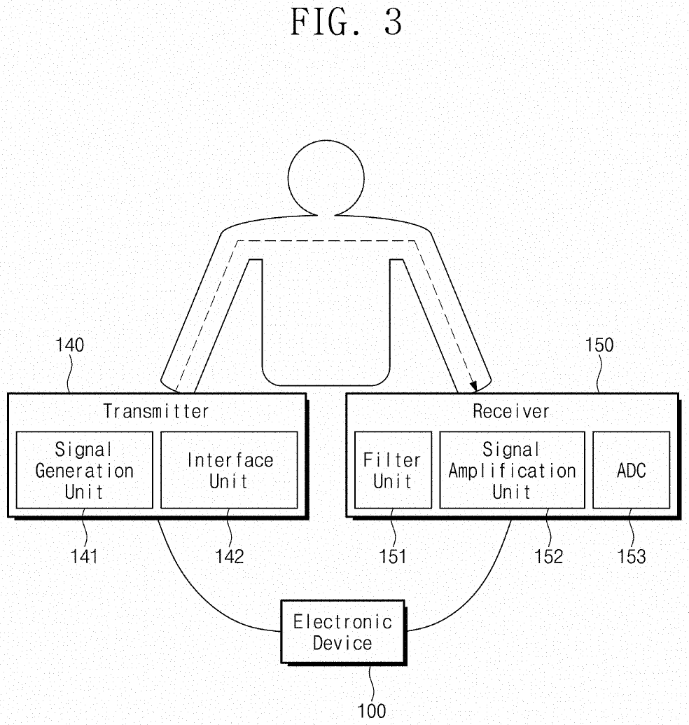

FIG. 3 is a diagram illustrating an example of the electronic device 100, according to an embodiment of the present disclosure. Referring to FIGS. 1 and 2, the electronic device 100 may measure and obtain a biometric channel response signal for generating a biometric template from a user by using the transmitter 140 and the receiver 150. For example, under the control of the processors 110, the transmitter 140 may transmit a signal for obtaining the biometric template to the user.

While the signal transmitted from the transmitter 140 passes through the user, a change in amplitude for each frequency and signal delay may occur due to a human body's unique response (or a biometric channel characteristic). The receiver 150 may obtain a biometric channel response signal that has passed through the user. The receiver 150 may transmit the obtained biometric channel response signal and information associated with the obtained biometric channel response signal to the electronic device 100. The change in amplitude for each frequency and the signal delay may be different for each user. Accordingly, the biometric channel response signal may be used to distinguish between users.

The transmitter 140 may include a signal generation unit, which generates a signal for obtaining a biometric template, and an interface unit for impedance matching according to user contact. In this case, the signal generation unit and the interface unit may be implemented by using firmware or software. For example, the firmware may be stored in the memory 130 and may be loaded and executed by the processors 110.

The signal generation unit may generate a signal for obtaining a biometric template. The signal for obtaining a biometric template may be a variable frequency signal belonging to a specified frequency band (e.g., 1 MHz to 10 MHz). For example, the signal generation unit may generate at least one of an up-chirp signal of which the frequency is increased during a given time and a down-chirp signal of which the frequency is decreased during a given time.

The interface unit may match impedance between a transmitter and a user. The interface unit may be an impedance matching circuit including a capacitor, a resistor, and the like. The impedance matching circuit may be variously implemented depending on applications, and may be set based on impedance values between the transmitter and the user.

The receiver 150 may include a filter unit, a signal amplification unit, and an analog-digital converter (ADC). The filter unit may perform filtering to obtain a biometric channel response signal from a signal received from the user. For example, the filter unit may remove noise from the signal received from the user. The signal amplification unit may amplify a signal in a specific frequency band in the signal received from the user. For example, the signal amplification unit may receive a signal passing through the filter unit and may increase the amplitude of the signal in a specific frequency band. The ADC may convert an analog signal into a digital signal. For example, the ADC may receive the signal passed through the signal amplification unit, may convert an analog signal into a digital signal, and may transmit a biometric channel response signal obtained from the converted result to the electronic device 100.

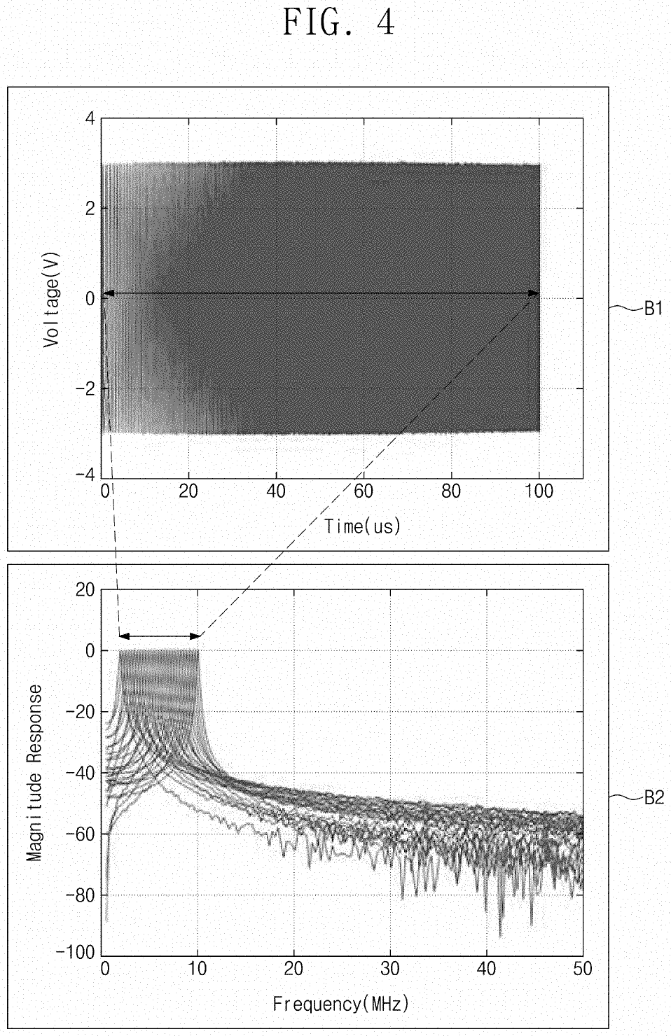

FIG. 4 illustrates a signal applied to a user to measure a biometric channel response signal, according to an embodiment of the present disclosure. A first box B1 shows a chirp signal of which the frequency is changed from 1 MHz to 10 MHz for 100 μs, and a second box B2 shows the sweep of the chirp signal. In the first box B1, a horizontal axis represents time and a vertical axis represents a voltage. In the second box B2, a horizontal axis represents a frequency, and a vertical axis represents the normalized magnitude response of Fourier transform. Referring to FIGS. 3 and 4, to measure a human body's unique response (or a biometric channel characteristic) in a given frequency band, the transmitter 140 may transmit a chirp signal for sweeping a frequency. For example, the transmitter 140 may transmit, to a user, at least one of an up-chirp signal of which the frequency is increased during a given time and a down-chirp signal of which the frequency is decreased during a given time.

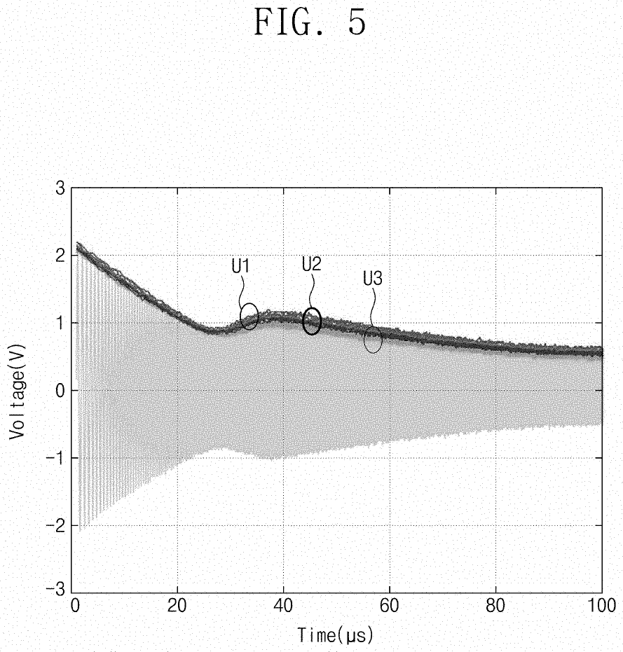

FIG. 5 illustrates feature signals of users obtained from biometric channel response signals, according to an embodiment of the present disclosure. In FIG. 5, a horizontal axis represents time, and a vertical axis represents a voltage. Feature signals may be obtained by connecting peak values of biometric channel response signals of users to generate envelope signals. Referring to FIGS. 3, 4, and 5, the transmitter 140 transmits the same signal (e.g., an up-chirp signal that increases in frequency from 1 Hz to 10 MHz for 100 μs) to users U1, U2, and U3. However, feature signals respectively obtained from the users U1, U2, and U3 may be different from one another. In more detail, changes in amplitude for each frequency and signal delay due to a body unique response (or a biometric channel characteristic) respectively corresponding to the users U1, U2, and U3 may occur in biometric channel response signals respectively corresponding to the users U1, U2, and U3. Accordingly, feature signals obtained from envelope signals generated by connecting the peak values of biometric channel response signals may be different from one another. Accordingly, at least one of the processors 110 may generate a unique biometric template from each of the users U1, U2, and U3 based on different feature signals.

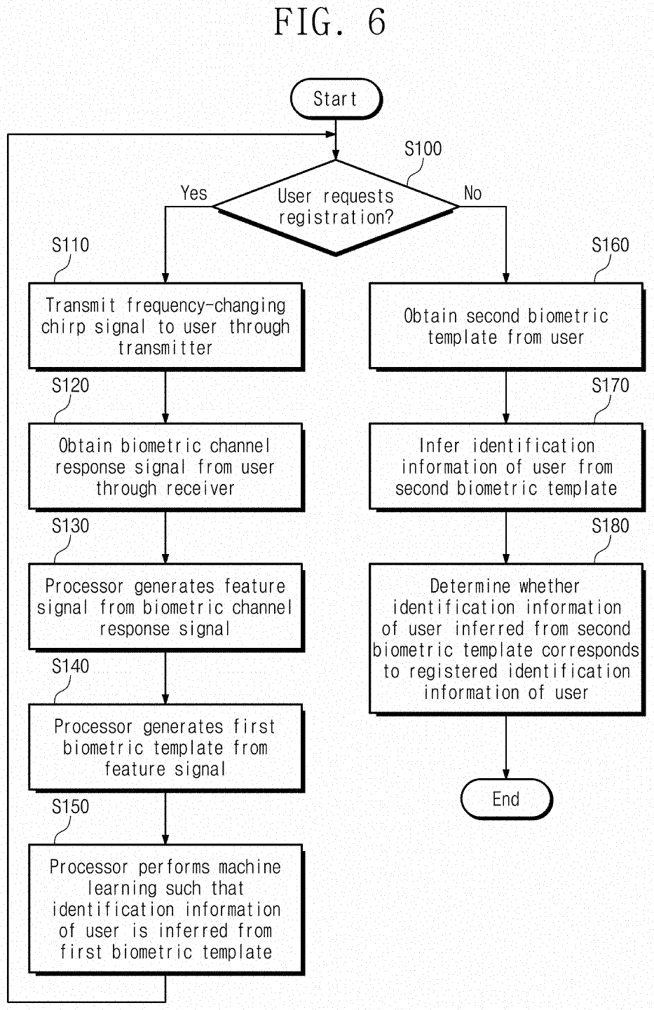

FIG. 6 is a flowchart of an electronic device by using a biometric template, according to an embodiment of the present disclosure. Referring to FIG. 6, the electronic device 100 may perform operation S100 to operation S180.

In operation S100, the electronic device 100 may determine whether a user's registration request is received. For example, under the control of the processors 110, the electronic device 100 may perform a user registration process (e.g., operation S110 to operation S150) in response to a fact that the user's registration request is received. The electronic device 100 may perform a user authentication process (e.g., operation S160 to operation S180) in response to a fact that the user's registration request is not received. At this time, operation S100 may be performed when the user's contact is identified by the transmitter 140 and the receiver 150.

In operation S110, the electronic device 100 may transmit a frequency-changing chirp signal to the user through the transmitter 140. For example, under the control of the processors 110, the transmitter 140 may transmit, to the user, an up-chirp signal of which the frequency is increased during a given time or a down-chirp signal of which the frequency is decreased during a given time. Moreover, under the control of the processors 110, the transmitter 140 may continuously transmit, to the user, the up-chirp signal of which the frequency is increased during a given time or the down-chirp signal of which the frequency is decreased during a given time. At this time, the signal generation unit of the transmitter 140 may generate the frequency-changing chirp signal, and an interface unit may perform impedance matching.

In operation S120, the electronic device 100 may obtain a biometric channel response signal from the user through the receiver 150. For example, the receiver 150 may obtain the biometric channel response signal from the chirp signal that has passed through the user. At this time, under the control of the processors 110, the filter unit of the receiver 150 may remove noise from the chirp signal passed through the user. Under the control of the processors 110, the signal amplification unit of the receiver 150 may increase the amplitude of a signal in a specific frequency band from a signal that has passed through the filter unit. Under the control of the processors 110, the ADC of the receiver 150 may convert the signal passed through the signal amplification unit into a digital signal, and the receiver 150 may obtain the biometric channel response signal.

In operation S130, at least one of the processors 110 may generate a feature signal for generating the biometric template from the biometric channel response signal. The feature signal may be obtained by detecting peak values from the biometric channel response signal and connecting the detected peak values to generate a plurality of envelope signals. For example, at least one of the processors 110 may execute the biometric template authentication module 200 and then may generate an envelope signal by connecting peak values of biometric channel response signals received from the receiver 150. The biometric template authentication module 200 may obtain a plurality of unique feature signals from the user and may generate a plurality of envelope signals corresponding to the user from a plurality of unique feature signals. At this time, the plurality of envelope signals may include an upper-envelop signal obtained by connecting upper peak values (e.g., maximum values) of a biometric channel response signal obtained from an up-chirp signal of which the frequency is increased, a lower-envelop signal obtained by connecting lower peak values (e.g., minimum values) of the biometric channel response signal obtained from the up-chirp signal, an upper-envelop signal obtained by connecting upper peak values of a biometric channel response signal obtained from a down-chirp signal of which the frequency is decreased, and a lower-envelop signal obtained by connecting lower peak values of the biometric channel response signal obtained from the down-chirp signal.

In operation S140, at least one of the processors 110 may generate a biometric template from a feature signal. For example, at least one of the processors 110 may execute the biometric template authentication module 200 and then may generate a first biometric template by combining a plurality of envelope signals. At this time, the plurality of envelope signals may include the upper-envelop signal and lower-envelop signal of the biometric channel response signal obtained from the up-chirp signal, and the upper-envelop signal and lower-envelop signal of the biometric channel response signal obtained from the down-chirp signal.

In operation S150, at least one of the processors 110 may perform machine learning such that the identification information of the user is inferred from the biometric template. For example, at least one of the processors 110 may perform machine learning such that the user is inferred from the first biometric template generated from the feature signal, by executing the biometric template authentication module 200. The biometric template authentication module 200 may store the result (e.g., identification information of the user) of machine learning in the memory 130. At least one of the processors 110 may repeat operation S110 to operation S140 to obtain data (e.g., a biometric template) required for machine learning, by executing the biometric template authentication module 200. In this case, the biometric template authentication module 200 may perform machine learning based on a plurality of biometric templates. The machine learning may be based on at least one of k-nearest neighbors (KNN), support vector machine (SVM), or convolutional neural network (CNN). In addition to the machine learning algorithm and the deep learning algorithm described above, the machine learning may be performed with various types of machine learning algorithms or deep learning algorithms.

When the user does not request registration in operation S100, operation S160 may be performed. In operation S160, the electronic device 100 may obtain a second biometric template for authentication from the user. For example, when the user does not request registration, the electronic device 100 may transmit a frequency-changing chirp signal to the user through the transmitter 140 to perform a user authentication process. At this time, the chirp signal may include at least one of an up-chirp signal and a down-chirp signal, each of which has an increasing frequency.

The electronic device 100 may obtain a biometric channel response signal from the user through the receiver 150. At least one of the processors 110 may generate a feature signal from the biometric channel response signal by executing the biometric template authentication module 200. The feature signal may be obtained by detecting peak values from the biometric channel response signal and connecting the detected peak values to generate a plurality of envelope signals. At least one of the processors 110 may execute the biometric template authentication module 200 and then may generate the second biometric template by combining a plurality of envelope signals. In this case, the plurality of envelope signals may include the upper-envelop signal and lower-envelop signal of the biometric channel response signal obtained from the up-chirp signal, and the upper-envelop signal and lower-envelop signal of the biometric channel response signal obtained from the down-chirp signal.

In operation S170, at least one of the processors 110 may infer the identification information of the user from the second biometric template. For example, at least one of the processors 110 may infer the identification information of the user for performing a user authentication process from the second biometric template by executing the biometric template authentication module 200. At least one of the processors 110 may repeat a process of generating a biometric template to obtain data (e.g., a biometric template) needed for inferring the user's identification information.

In operation S180, at least one of the processors 110 may determine whether the identification information of the user inferred from the second biometric template corresponds to the registered identification information of the user. For example, at least one of the processors 110 may determine whether the identification information of the user inferred from the second biometric template corresponds to the identification information of the user stored in the memory 130. At least one of the processors 110 may complete authentication in response to a fact that the inferred identification information of the user corresponds to the identification information stored in the memory 130. At this time, at least one of the processors 110 may provide the user with an authentication result indicating that the authentication is successful, through at least one of the user interfaces 160.

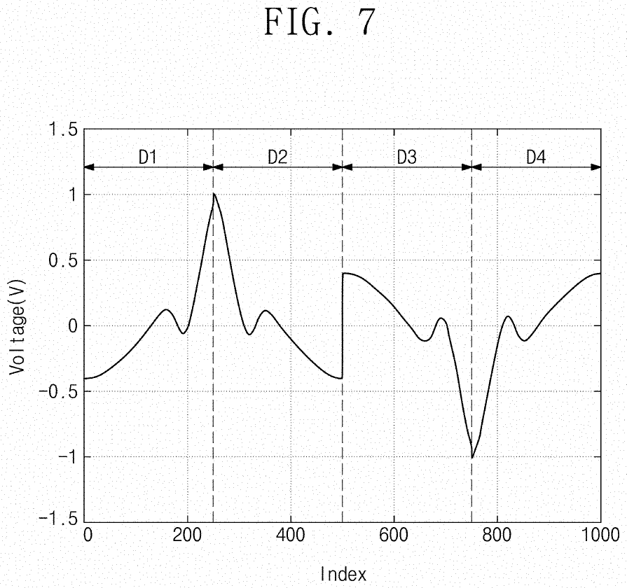

FIG. 7 illustrates a generated biometric template, according to an embodiment of the present disclosure. In FIG. 7, a horizontal axis represents an index, and a vertical axis represents a voltage. Referring to FIGS. 6 and 7, a biometric template may be generated from a feature signal. For example, the feature signal may be obtained by detecting peak values from a biometric channel response signal and connecting the detected peak values to generate a plurality of envelope signals. The biometric template may be generated by combining the plurality of envelope signals. At this time, the plurality of envelope signals may include an upper-envelop signal D2 and a lower-envelop signal D4 of a biometric channel response signal obtained from an up-chirp signal, and an upper-envelop signal D1 and a lower-envelop signal D3 of a biometric channel response signal obtained from a down-chirp signal.

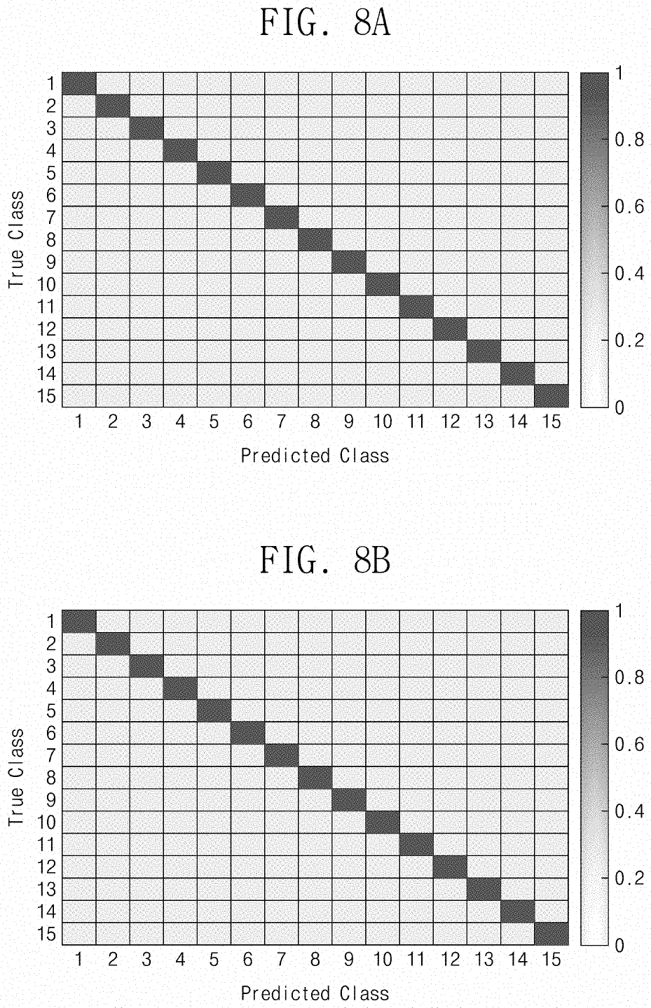

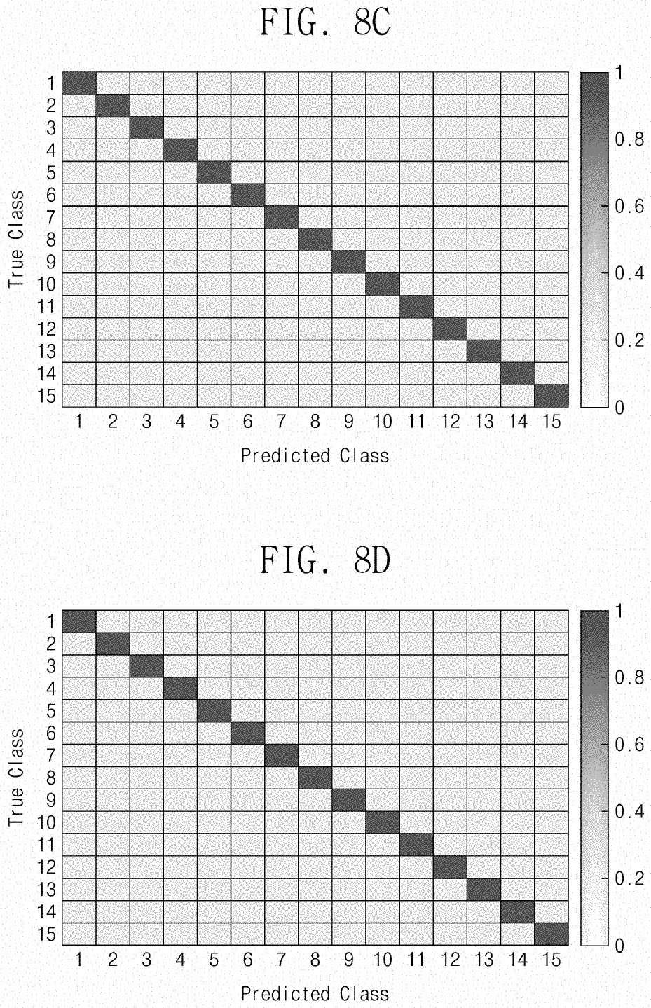

FIGS. 8A to 8D illustrate authentication results according to KNN and SVM algorithms for 15 users, according to an embodiment of the present disclosure. In FIGS. 8A to 8D, a horizontal axis represents a predicted class, and a vertical axis represents a true class. N_{dw} may mean the number of samples constituting a biometric template. FIG. 8A shows a result of performing KNN algorithm when N_{dw} is 500. FIG. 8B shows a result of performing KNN algorithm when N_{dw} is 50. FIG. 8C shows a result of performing SVM algorithm when N_{dw} is 500. FIG. 8D shows a result of performing SVM algorithm when N_{dw} is 50. Referring to FIGS. 8A to 8D, in authentication through the electronic device 100, the machine learning algorithm type or N_{dw} may not affect reliability. For example, a result of performing authentication of the electronic device 100 based on the same N_{dw} (e.g., 50 or 500) indicates that the type (e.g., KNN or SVM) of algorithm may not affect reliability. Moreover, a result of performing authentication of the electronic device 100 based on the same machine learning algorithm (e.g., KNN or SVM) indicates that N_{dw} (e.g., 50 or 500) may not affect reliability.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, an electronic device performs authentication using a biometric channel response characteristic, thereby providing the high accuracy and stability of authentication. Accordingly, security is possible without the risk of forgery and leakage. In addition, authentication may be performed in an intuitive and quick process with a momentary touch.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a memory;
a transmitter configured to transmit a chirp signal, of which a frequency is changed, to a user;
a receiver configured to obtain a biometric channel response signal, which responds to the transmitted chirp signal, from the user; and
at least one processor configured to execute a biometric template authentication module based on machine learning,
wherein, when executing the biometric template authentication module, the processor is configured to:
obtain a feature signal from the obtained biometric channel response signal;
generate a biometric template from the obtained feature signal;
perform the machine learning such that identification information of the user is inferred from the generated biometric template; and
authenticate the user based on the result of the machine learning.

2. The electronic device of claim 1, wherein the obtaining of the feature signal includes:
generating a plurality of envelop signals corresponding to peak values of the obtained biometric channel response signal.

3. The electronic device of claim 2, wherein the generating of the biometric template includes:
generating the biometric template by combining the generated plurality of envelop signals.

4. The electronic device of claim 2, wherein the plurality of envelop signals include an upper-envelop signal and a lower-envelop signal.

5. The electronic device of claim 1, wherein an up-chirp signal having an increasing frequency and a down-chirp signal having a decreasing frequency, which are included in the chirp signal, are continuous.

6. The electronic device of claim 1, wherein the receiver is configured to:
filter the biometric channel response signal to remove noise;
amplify the filtered biometric channel response signal; and
convert the amplified biometric channel response signal into a digital signal.

7. The electronic device of claim 1, wherein the machine learning is based on at least one of k-nearest neighbors (KNN), support vector machine (SVM), or convolutional neural network (CNN).

8. An operating method of an electronic device registering a biometric template by using a processor, the method comprising;
transmitting, by the processor, a chirp signal, of which a frequency is changed, to a user through a transmitter;
obtaining, by the processor, a biometric channel response signal, which responds to the transmitted chirp signal, from the user through a receiver;
obtaining, by the processor, a feature signal from the obtained biometric channel response signal;
generating, by the processor, a first biometric template from the obtained feature signal; and
performing, by the processor, machine learning such that identification information of the user is inferred from the generated first biometric template.

9. The method of claim 8, further comprising:
receiving a registration request of the user,
wherein the performing, by the processor, of the machine learning is performed in response to the registration request of the user.

10. The method of claim 8, further comprising:
authenticating the user based on the result of the machine learning.

11. The method of claim 10, wherein the authenticating of the user includes:
obtaining a second biometric template from the user; and
inferring the identification information of the user from the second biometric template.

12. The method of claim 8, wherein the machine learning is based on at least one of KNN, SVM, or CNN.

13. The method of claim 8, wherein the obtaining of the feature signal includes:
generating a plurality of envelop signals corresponding to peak values of the obtained biometric channel response signal.

14. The method of claim 13, wherein the generating of the first biometric template includes:
generating the first biometric template by combining the generated plurality of envelop signals.

15. The method of claim 13, wherein the plurality of envelop signals include an upper-envelop signal and a lower-envelop signal.
